(19) United States
(12) Patent Application Publication
(10) Pub. No.: US 2013/0133301 A1
(43) Pub. Date: May 30, 2013

(54) MODULAR AIR FILTER

(71) Applicants: Gregory Vance Sproule, Linden, MI (US); Richard Shane Nagy, Wyandotte, MI (US)

(72) Inventors: Gregory Vance Sproule, Linden, MI (US); Richard Shane Nagy, Wyandotte, MI (US)

(73) Assignee: GENERAL FILTERS, INC., Novi, MI (US)

(21) Appl. No.: 13/305,146

(22) Filed: Nov. 28, 2011

(51) Int. Cl. B01D 46/00; B01D 46/42; B23P 11/00; B01D 46/52

(52) U.S. Cl. 55/480; 55/511; 55/499; 55/501; 55/481; 29/428

(57) ABSTRACT

An air filter for exemplary use with forced air circulation systems includes a modular media core having rigid top and bottom media supports that are connectable with a variety of axial supports to form a high efficiency air filter cartridge useful with many different types of air circulation systems.

### TECHNICAL FIELD

The present invention generally pertains to the filtration of forced air. The invention has particularly useful application for use in filtering interior air in residential structures.

### BACKGROUND

The need for filtering interior air in enclosed structures inhabited by humans has long been known as necessary for a clean and healthy living environment. Filters used in forced air systems, wherein air is forcibly moved through a space for heating, cooling and/or filtering air have come in many shapes and sizes. Conventional filters for residential homes typically are installed in a portion of a furnace where air is forcibly drawn through the filter to remove particulates to clean the air for a cleaner and healthier interior environment.

Conventional filters include media through which the air flows to catch and prevent passage of undesired particles. Filter media have included many materials ranging from randomly oriented fiberglass fibers, paper and other materials depending on the level of filtration desired. Prior filter media were commonly were oriented in a planar panel or may be pleated in an accordion-like fashion to increase the surface area through which the air passes to increase the level of filtration and increase the service life of the filter.

Conventional filters have suffered from several disadvantages. When the filters become clogged with sufficient particulate, the filters become inefficient and deter the passage of air forcing the forced-air system to work harder to circulate air to and from the living space. Conventional filters have included structurally weak support structures or peripheral frames intended to keep the filter media oriented substantially planer in the intended enclosure, for example a slot in an air duct in a residential furnace. Such filters, for example when they become clogged or frame structures become damp from humidity, buckle and distort allowing the filter media to deform further blocking the flow of air and placing even more force on the filter. Such poor designs and performance, under the substantial air flow and pressure, greatly reduce the operability and efficiency of the filter and can even pull the filter from its intended position and draw it into the forced air system causing extensive damage to the expensive equipment.

Conventional filter cartridges have further been specifically designed for a particular application, for example, forced air furnaces and can only accommodate different sizes of enclosure. Air circulation equipment manufacturers have numerous designs which are often unique and require a specific form of filter cartridge to operate with a particular system. Consumers and users are disadvantaged as few or only a single source is offered to purchase replacement filters from at elevated costs. These filters equally have suffered from structural and performance deficiencies while having limited filtration capabilities.

Conventional filters having fixed or rigid frame structures are large and bulky requiring considerable space for manufactures to manufacture ship and warehouse installation-ready filters. Manufacturers have attempted to design filters that are collapsible to some extent to take less space for storage and shipment. These collapsible designs required complex and expensive frames to reduce the size and required difficult processes to assemble the filter in the field for use.

It would be advantageous to improve on or solve these deficiencies and problems in prior filter designs. It would be advantageous to design a modular or substantially universal filter cartridge which has a high level of filtration capability and is collapsible to reduce the space required for shipment and is easy to assemble in the field.

It would be further advantageous for a filter to be readily adaptable to accessories which render it useful in a larger number of systems over that of prior filters while remaining simple to assemble and install in the field.

It would further be advantageous to have a structurally robust modular filter which improves the rigidity, strength and durability for long service life over prior filters while maintaining ease of manufacture and cost efficiency to produce and sell.

### BRIEF SUMMARY

The present invention includes an air filter for exemplary use with forced air systems. In one example, a modular filter media core is used having robust first and second media support structures connected to the top and bottom portions of a collapsible and/or expandable filter media having a high surface area for the capture of particulates in a flow of forced air through the media. The modular media core is readily connectible or adaptable with different axial supports in the form of end panels or accessories and options allowing the media core to be used with a plurality of end panels which allow the media core to be used in a plurality of different filtration systems and applications.

In one example, robust media support structures include a closed rectangular section of a continuous material that is overlapped and secured to itself forming a through cavity having open ends. When the filters become clogged with sufficient particulate, the filters become inefficient and deter the passage of air forcing the forced-air system to work harder to circulate air to and from the living space. The strength, rigidity and robust characteristics of the media supports when combined with the inventive media core, provide superior structural characteristics and performance of the filter which is a significant improvement over prior filters and improves on and/or solves problems with prior filter designs.

In one example, the modular media core is used several variations of axial side support end panels. In one example of the axial end panel supports each include a single rigid end panel defining an elongate channel wherein the modular media core is inserted into the channel which vertically (or horizontally) extends and/or supports and maintains the orientation of the media core panel.

In another example of the end panel support, the end panels include connectors having inserts which are installed into the through cavity in each of the core media supports at the top and bottom of the media.

In another example of the end panel supports, each end panel includes a first portion and a second portion which are hinged at a joint of the portions and hinged where the connector inserts attach to the media supports at the top and bottom of the filter media. The hinged supports allow the modular core to collapse and ready be extended to an operating height for use.

In another example of the filter, the media core is used with a support in the form of a rigid cabinet having top and bottom rail structures which slidingly accept the robust media supports on the top and bottom of the media to position and orient the media core in an extended and operable position for use.

In another example, the media core media supports includes elongate rails connected to the top and bottom of the media support structures for sliding attachment to a rigid cabinet having coordinating rail structures to position and orient the media core in an extended and operable position for use.

In one method, the media core is formed and connected to one of a plurality of axial end supports to expand the media core along an axis and thereafter held in an extended position by the axial end supports.

Other examples and variations of the above described and illustrated below known by those skilled in the art may be used.

### BRIEF DESCRIPTION OF THE DRAWINGS

The description herein makes reference to the accompanying drawings wherein like reference numerals refer to like parts throughout the several views, and wherein:

FIG. 1 is a perspective view of one example of a modular filter media core having robust media supports on the top and bottom of the filter media;

FIG. 2 is a partial left end view of the example shown in FIG. 1;

FIG. 3 is a cross-sectional view taken along line 3 in FIG. 1;

FIG. 4 is a perspective view of the exemplary filter having the media core shown in FIG. 1 with an example of a vertical end panel side support that is permanently attached;

FIG. 5 is a perspective view of the exemplary filter using the media core shown in FIG. 1 with an alternate example of vertical end panel supports that are removable;

FIG. 6 is an enlarged perspective view of a portion of the end panel support shown in FIG. 5;

FIG. 7 is a perspective view of the exemplary filter using a media core shown in FIG. 1 with an alternate example of multi-hinged vertical end panel supports shown in a collapsed position;

FIG. 8 is an enlarged perspective view of the exemplary hinged end panel shown in FIG. 7;

FIG. 9 is perspective view the media core in FIG. 1 used with a vertical support in the form of a rigid cabinet having a rail structure for engagement of the media support structures;

FIG. 10 is an enlarged perspective view of a portion of the filter shown in FIG. 9; and

FIG. 11 is a partial perspective view of an alternate example of the media core shown in FIG. 1; and

FIG. 12 is a schematic flow chart of an example of a method for assembling an air filter.

### DETAILED DESCRIPTION OF EMBODIMENTS OF THE INVENTION

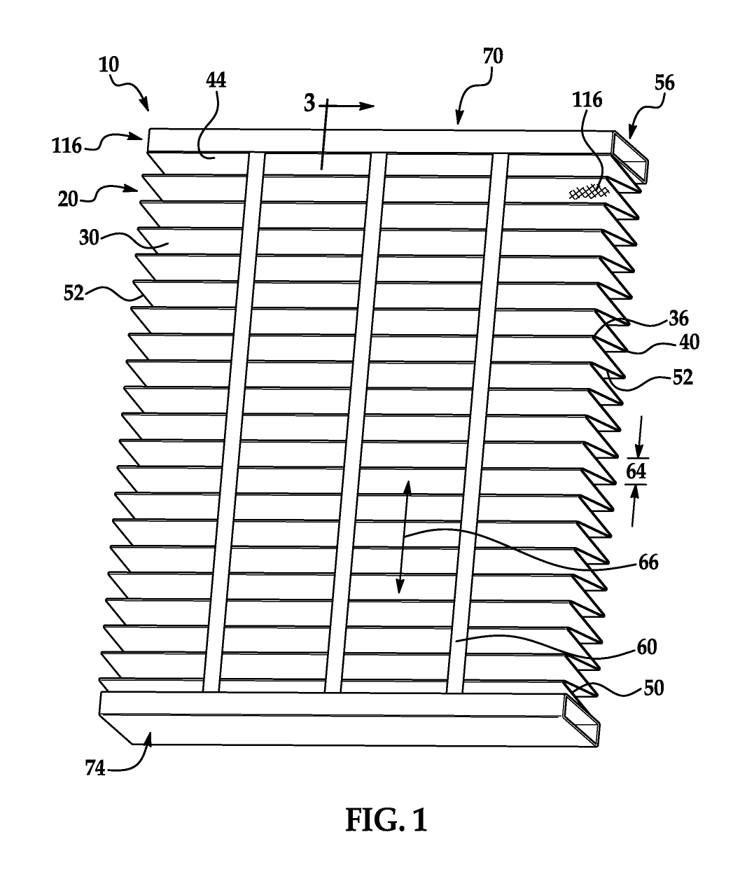

Several examples of an inventive air filter 10 and methods of assembly 300 are illustrated in FIGS. 1-12 and described below.

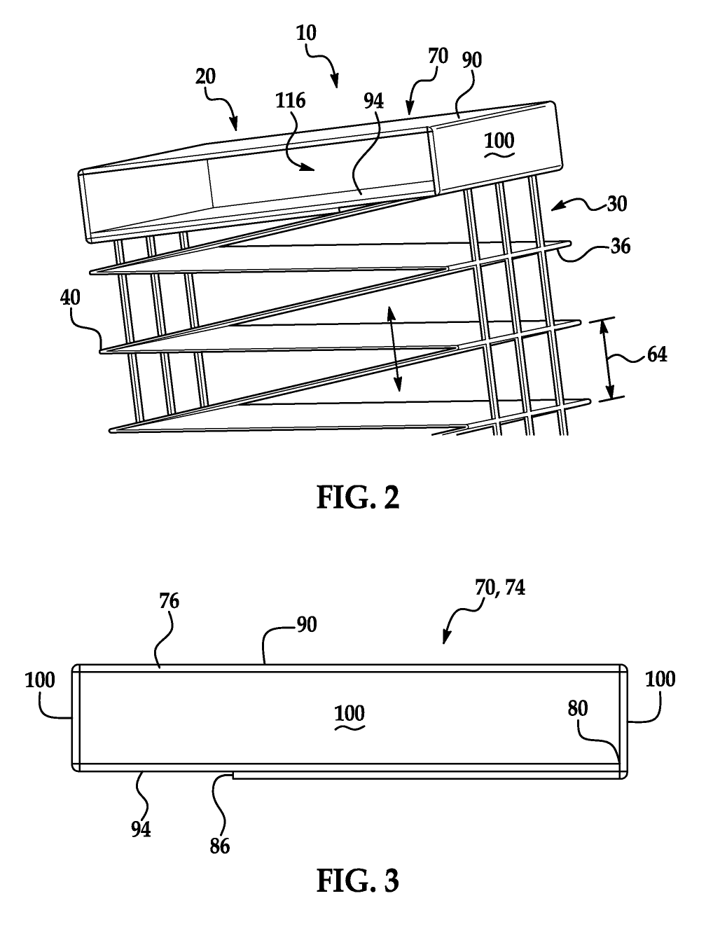

Referring to FIGS. 1 and 2, an example of an air filter 10 with a modular air filter media core 20 is illustrated. In the example, media core 20 includes a filter media 30. In a preferred example, filter media 30 is a single, continuous textile which is pleated in alternating orientation forming front 36 and back edges 40 to produce an accordion-like, collapsible filter media as best seen in FIG. 2. Media 30 further includes a top 44 and bottom 50 pleated panel integral with media 30. In the preferred example, the media can be collapsed in height (or length in a horizontal application) along an axis 66 to a small height or profile as generally shown in FIG. 7 and selectively extended to a full or operable height as shown in FIG. 1.

In a preferred example, filter media 30 is made from non-woven synthetic fibers which are bonded together. Examples of the fibers are polypropylene and polyolefins. It is understood that other flexible textiles, other materials and alternate constructions and configurations known by those skilled in the art may be used.

In one example, core 20 further includes a reinforcing backing material 56 that is connected to the outside of media 30 in selected areas. In a preferred example, backer 56 is attached either the front or rear side of media 30 and is formed in a pleated fashion along with media 30. Backer 56 provides sufficient structural support for the relatively thin media 30 while allowing the media 30 to easily collapse and extend as described. Backer 56 is preferably made from a lightweight metallic mesh material. Other materials, configurations and connection to media 30 known by those skilled in the art may be used.

Referring to FIG. 1, filter core 20 further includes one or more separators 60 (three shown) connected to the media front edges 36 in a position and orientation as generally shown. In one example, separators 60 are flexible, textile material that are connected to each front edge 36 by adhesive. The separators 60 operate to maintain a substantially equal distance or space 64 between the pleats or respective front 36 and rear 40 edges when the media 30 is extended to a full height or operable position as shown in FIG. 1. Separators 60 are flexible and allow the media 30 to easily collapse and extend as described above. It is understood that other materials, constructions and attachment methods for separators 60 may be used as known by those skilled in the art.

Referring to FIGS. 1-3, an example of first 70 and second 74 media supports are illustrated. In the example, each media support 70 and 74 is in the form of a structural, closed, rectangular section as best seen in FIGS. 2 and 3. Each support 70 and 74 is preferably made from a continuous piece of material having first edge 80 and a second edge 86. In a most preferred example, the material is a corrugated cardboard that is thin, lightweight and fairly rigid. Other materials, for example, fiberboard, chip board, polymers, elastomers and other materials known by those skilled in the art may be used. This substantially rigid structural member functions to provide support and structure to, among other things, maintain the shape and orientation of the media in operating conditions where prior filters have not performed well and have failed during their service lives. This is a significant improvement over prior designs which perform poorly and fail, for example, in high humidity conditions or environments.

As best seen in FIG. 3, it has been discovered that the rectangular section shown is particularly useful in these objectives. In the example, the continuous material is manufactured to fold the material adjacent second edge 86 to overlap a portion adjacent the first edge 80 forming a top 90, a bottom 94 and sides 100 as generally illustrated. In a preferred example, the width of the top 90 and bottom 94 are about the same width of the media material, for example about 5 inches (127 millimeters). In a preferred aspect, the sides are approximately inches 1 (25 millimeters) in height. As best seen, the length of media supports 70 and 74 are approximately the full length of the media 30. It is most preferred that the length of media supports 70 and 74 is slightly shorter than the media 30. This prevents undesirable gaps from forming around the media 30 allowing the forced air to pass through the filter without passing through the media 30. The manufactured, closed section support 70, 74 each defines a through cavity 110 between the support edges 116. It is understood that different sizes of media supports 70 and 74 may be used to suit the particular application, although it is an object of the invention for the filter 10 to be as compatible with as many systems and to have as few of different sizes as possible.

In a preferred aspect, three parallel beads of adhesive and positioned on one or the other of the opposing faces and pressure applied to compress and rigidly secure the opposing faces together to form the rectangular section as generally shown. It is understood that other sections, constructions, materials, numbers of components may be used to form the robust supports and other methods of securing the section together as known by those skilled in the art may be used.

Referring to FIGS. 1 and 2, first media support 70 is preferably secured to the media 30 at the top panel 44 and the second media support 74 to the media 30 bottom panel 50 as best seen in FIG. 1. In a preferred example, adhesive is used to securely connect the supports 70 and 74 to the adjacent media panel. As best seen in FIG. 3, in a preferred aspect, the media top panel 44 is preferably secured to the media support bottom panel 94 over the overlap joint of second edge 86 to take advantage of the additional adhesive and double thickness of material in the support panel overlap joint for increased strength and rigidity (gap shown between 44 and 94 for purposes of illustration only). In an alternate example, the media support top panel 90 is used as the face to secure to the respective media panel to provide an uninterrupted surface to adhere to the media 30. Other orientations and methods of securing supports 70 and 74 to the medial 30 known by those skilled in the art may be used.

When supports 70 and 74 are secured to the media 30, a modular filter core 20 is formed which provides a sturdy and robust filter media when installed with several different vertical end panel devices or accessories described below, adaptable for use in many different forced air circulation devices unlike prior art filter media or cartridges which are often specific to a particular application.

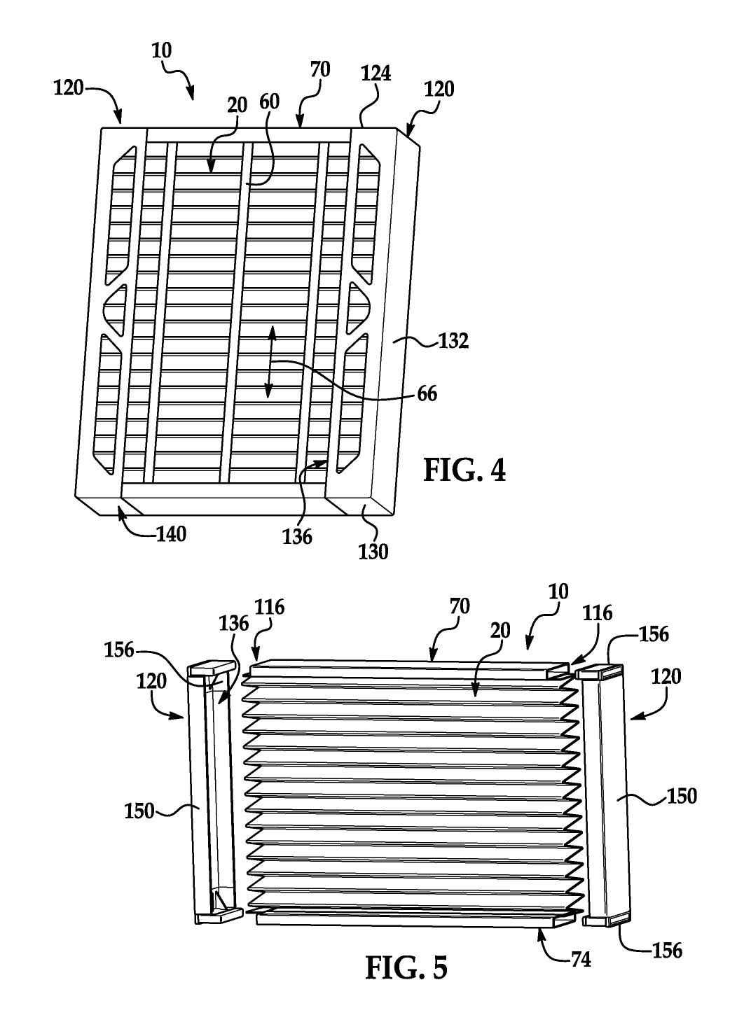

Referring to FIG. 4, an example of filter core 20 in combination with one example of axial end supports 120 which are secured to core 20 to extend (either vertically or horizontally depending on the application and installation method of the filter) the media core along axis 66 and hold the core 20 and media 30 in an extended and operable position. In the example illustrated where the filter 10 is used in a vertical or upright application, elongate axial side support 120 are in the form of end panels including a top end 124 and bottom end 130 separated by sides 132. The top, bottom and sides forming a channel 136 between the top and bottom for sliding receipt of the filter core 20 as generally shown. In the example, the core first 70 and second 74 supports are secured to the respective vertical supports 120 by adhesive forming a non-collapsible core 20 and filter 10 cartridge once the filter core 20 is assembled/connected to the end panels 120 as described. In an alternate example, bendable tabs on one or both of the core supports 70 and 74 and/or end panels 120 to secure the end panels 120 to the core may be used.

Other ways of securing the end panels 120 to the core 20 known by those skilled in the art may be used. In one example not shown, open cell foam seal, in the form of adhesive backed foam strips, are secured to an outer periphery of the filter 10 (supports 70, 74 and vertical support sides 132) to further deter forced air from passing around the filter 10 avoiding passage through media 30. Other examples of vertical end panel supports 120 known by those skilled in the art may be used. It is understood that the illustrated filters 10, for example that shown in FIG. 4, may be oriented horizontally so the media pleats are oriented vertically and the end panels 120 are positioned horizontally, to suit the particular application as known by those skilled in the art.

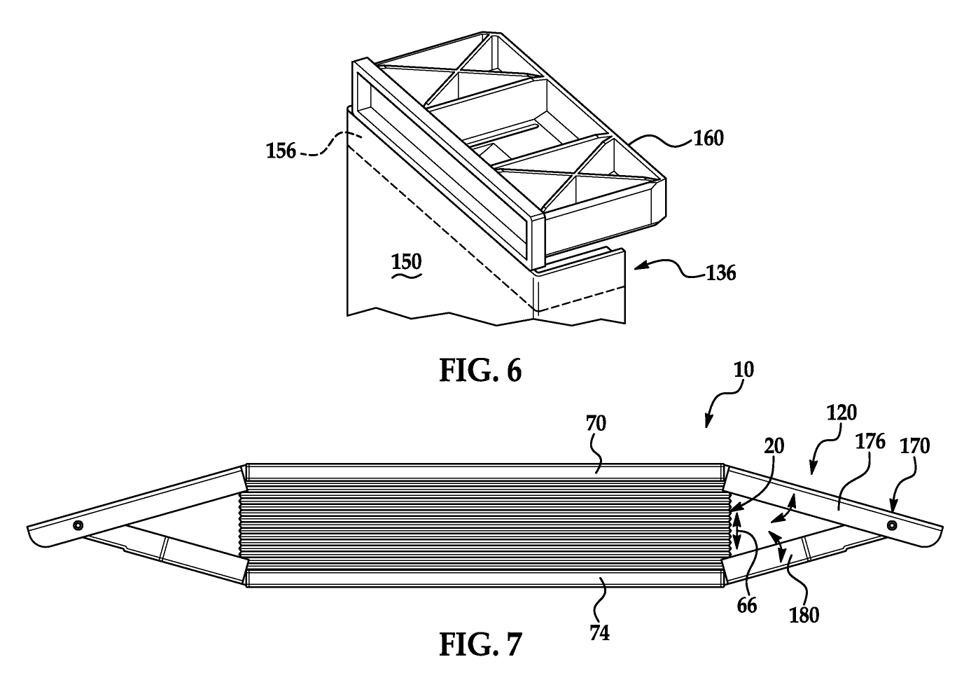

Referring to FIGS. 5 and 6, an alternate example of axial end supports 120 used in combination with media core 20 is illustrated providing an example of an expandable filter as understood in the field of technology. In the example, end supports 120 are in the form of removable axial end panel side supports 150 having concave channels 136 similar to that previously described. In the example, axial end panels 150 include connectors 156 on opposing ends, each connector having insert 160 transversely extending away from the end panels 150 as generally shown. In one example, the connectors 156 are secured to the end panels 150 with adhesive and the inserts are formed integral with the connectors. When it is desired to form a filter 10 with media 30 extended and ready for use, end supports 150 including connectors and inserts 160 are slidingly engaged so that media 30 is positioned in the channels 136 and inserts 160 are slidingly received in the respective support 70 and 74 ends 116 and cavity 110.

In one example, axial end panel supports 150 are secured to core 20 through frictional engagement of the inserts 160 with the support 70 and 75. In alternate examples not shown, tabs, clips or other fastening devices known by those skilled in the art may be used. As the vertical end panel supports 150 are removable, when the media 30 becomes clogged or at the end of its service life, the end panels 150 are removed and a new core 20 is installed. In this application, until assembly of a filter 10 is needed, the core 20 can remain in a collapsed, compact position. The core 20 and end panel supports 150 can be packed together or separately for a compact assembly for shipping from the manufacturing facility or for installation in the field.

In one example, axial end panel supports 120 and 150 are preferably made from rigid fiberboard and other materials as described for supports 70 and 74. In a preferred example, connectors 156 and inserts 160 are integrally molded from a polymer. Other materials, for example rigid paper, foam, elastomers and lightweight metals known by those skilled in the art may be used. Other removable vertical end panel supports 150, connectors 156 and inserts 160, in size, shape, configuration and orientation known by those skilled in the art may be used. It is further understood that although end panels 150 may be constructed and installed to media 30 as described above, end panels 150 can be permanently attached at installation and be discarded as a unit along with the used media 30 at the end of the service life.

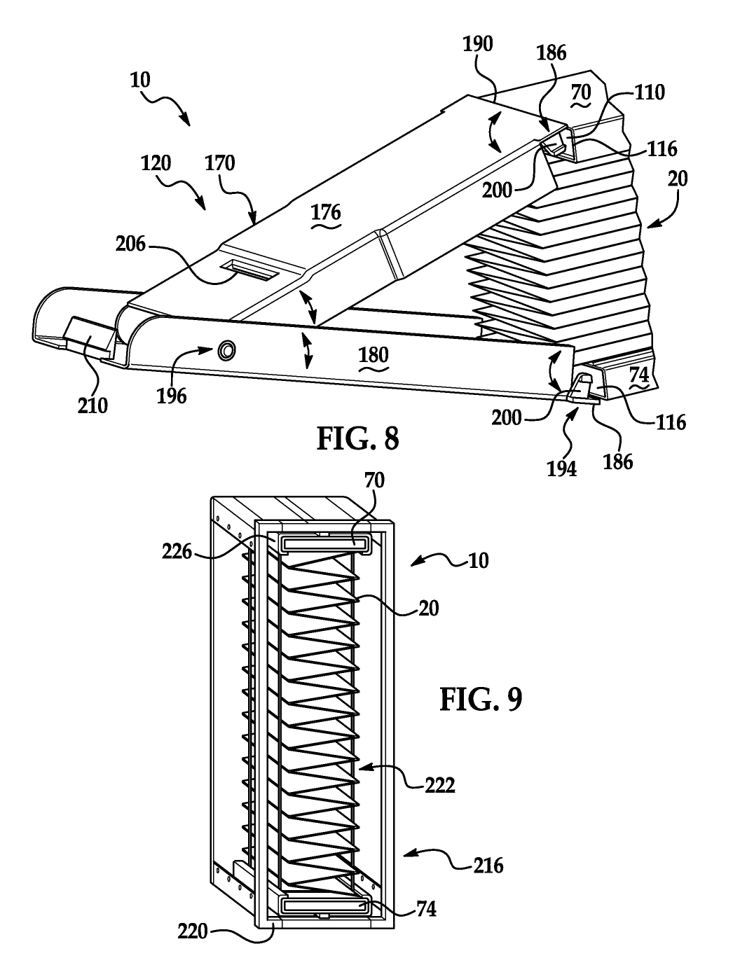

Referring to FIGS. 7 and 8, an alternate example of axial side supports 120 for use in combination with filter core 20 is illustrated. In the example, end panel side supports 120 are in the form of a multi-hinged axial end panel supports 170. In the example, axial end panel supports 170 include a first portion 176 and a second portion 180, each portion including a connector 186 for hinged connection to a respective core support 70 or 74. In a preferred example, end panel supports 170 are used in a vertical orientation to extend and lock the media 30 in a vertical orientation.

In the example, connectors 186 are connected to the respective first 176 or second portions and a portion of the connector in the form of an insert is inserted into the respective core support 70 and 74 cavity 110. In the example, connector 186 inserted into first support 70 includes a first hinge 190 and the connector 186 inserted into second support 74 includes a second hinge 194 allowing the respective first 176 and second 180 to rotate relative to the supports 70 and 74. End panels 170 further include a third hinge 196 rotatably connecting the other ends of the first 176 and second 180 portions allowing relative rotation therebetween.

In one example, one or more locking tabs or bars are used the further secure the axial end panels 170 in a fully-extended vertical position wherein the core 20 is extended and ready for use. In one example, connectors 186 include locking tabs 200. In the example shown first portion 176 defines an opening or slot 206 and second portion 180 includes a coordinating locking bar 210 wherein on rotation of the vertical supports 170 toward an extended position, locking bar 210 passes through and engages opening 206 which resists removal of locking bar 210 keeping the vertical support 170 in an upright, operable position of the media 30.

In the example shown in FIGS. 7 and 8, hinged end panel supports 170 allow the core 10 to be collapsed in a first or compact position as shown in FIG. 7 when not extended and in an operable position. As the filter 10 is extended as best seen in FIG. 8, the hinged vertical supports 180 first 176 and second 180 portions rotate relative to one another and are secured in a second or vertical or extended position in the manner described. In a preferred example, first 176 and second 180 portions are made from a rigid polymer material. Other materials, constructions and orientations of hinged vertical supports known by those skilled in the art may be used. In the expandable versions of filter 10 shown in FIGS. 5 and 7, the described inventions provide significant improvements in structure, efficiency and performance over prior expandable filter designs which suffer from disadvantages of weak and flimsy frame and support structures. The prior designs typically allow a high level of gaps or passageways for forced air to move around and avoid passing through the filter creating a relatively low level of efficiency.

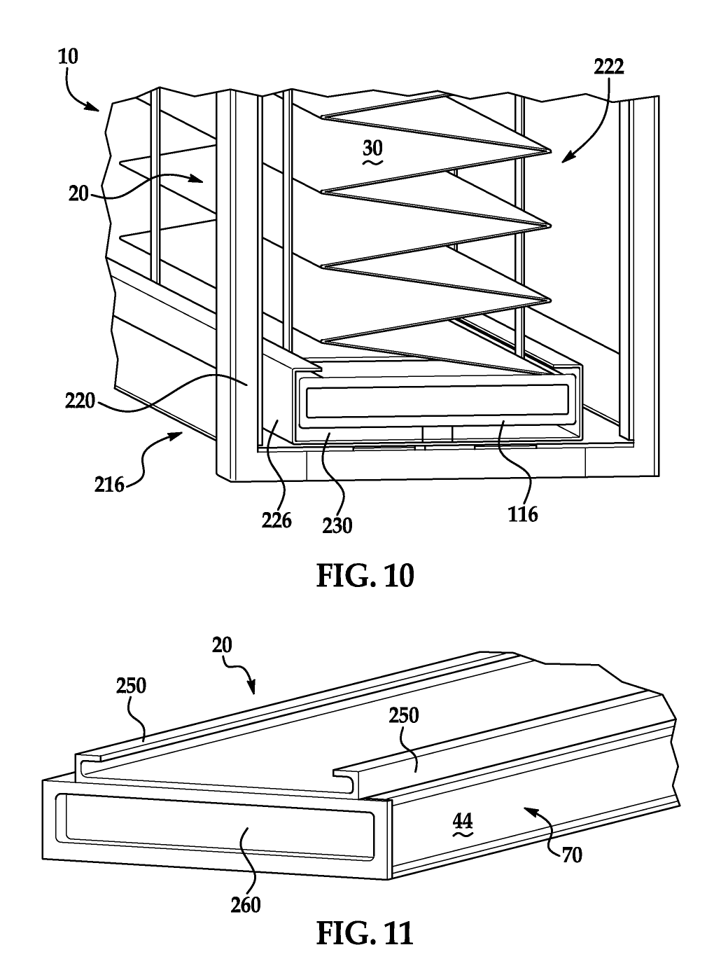

An alternate example of filter 10 shown in FIGS. 9 and 10 and the media axial end supports are shown in the form of a rigid cabinet 216. In the example, cabinet 216 includes a rigid frame 220 defining an interior cavity 222 as generally shown. In a preferred example, frame 222 includes two pairs of open channel rails 226 connected to the top and bottom of the cabinet as generally shown. The rails 226, or alternatively the size of core 20 supports 70 and 74, are sized to slidingly engage the respective rail 226 which, when shaped as formed, prevents the respective support from vertically pulling out of the rail and must be removed through sliding the support in a direction parallel to the rails. When the core 20 supports 70 and 74 are secured in the respective rail 226, the media 30 is positioned in an extended and operable height forming a filter 10. Other constructions, sizes, shapes and orientations of rails 226 and cabinet 216 may be used by those skilled in the art.

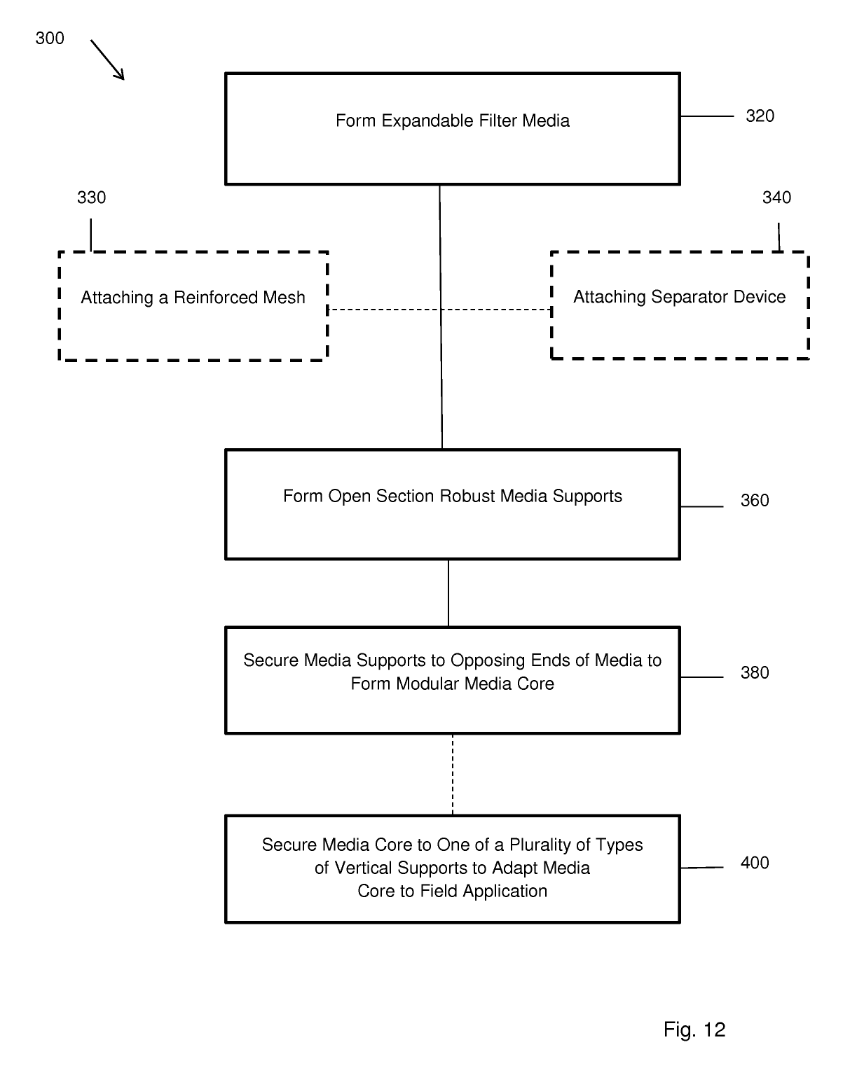

In the example shown in FIG. 11, core 20 includes rail structures 250 secured to the top surface of the respective core support 70 and/or 74 vertically extending away from the support (rails 250 shown on support 70 for exemplary purposes only). Rails 250 are sized and shaped to receive coordinating structures (not shown) in, for example, a cabinet 216 for example shown in FIG. 9. When rails 250 are slidingly engaged with the coordinating structures extend media 30 to an operable height and deter removal of the filter axially against the rails. Removal of the core 20 is preferably through sliding disengagement of the rails 250 with the coordinating structures of the cabinet or other structures known by those skilled in the art. In the example shown, a decorative end cap 260 is inserted to close the first media support 70 open end cavity 110. Other examples may be used.

As shown in FIG. 12, an example of a process for making a modular air filter 300 is generally illustrated. In the example, process step 320 includes forming a pleated air filter media useful in force air circulation systems. In one example, the media 30 can be used in a continuous roll and through a rotating auger device (not shown), the media 30 alternatingly folded back in itself to form a pleated, accordion-like structure as best seen in FIG. 1. The media is thereafter cut to length.

In alternate process step 330, the reinforcing material, for example wire mesh 56, can be simultaneously rolled out and pleated along with media 30. Alternate methods of attaching a reinforcement to the media 30 known by those skilled in the art may be used.

In an alternate step 340, following pleating of the media 30, and while the auger or other device positions the pleats so that the spaces 64 are substantially equal, separator 60 is secured to the front 36 or rear 40 edges through adhesive. In the example shown in FIG. 1, separator 60 includes three (3) independent textile ribbons which are secured with precisely positioned drops of adhesive on each of the respective media edges to produce the media and separator generally shown in FIG. 1. Alternate separators and methods of connection to media 30 known by those skilled in the art may be used.

In the example shown in FIG. 12, the robust media supports 70 and 74 are formed in step 360. In the example, a continuous piece of material, for example relatively rigid corrugated cardboard is folded to produce an open, rectangular section with a portion of the first 80 and second 86 edges overlapping in an area in which adhesive is applied to secure the overlap area together producing a robust, relatively rigid support structure. It is understood that the supports 70 and 74 can be made in a separate assembly area and the order in the process shown in FIG. 12 can vary.

In process step 380, the supports 70 and 74 are secured to the opposing cut ends of the media through adhesive or other means to form the modular filter core 20. Other ways and process steps to secure the supports to the top 44 and bottom 50 panels of the media 30 known by those skilled in the art may be used. In this construction, modular filter core 20 is a high efficiency filter media that can be readily used with a plurality of vertical support devices or systems to suit the particular existing equipment or application.

In optional step 400, the modular filter core 20 is secured to one of a plurality of vertical supports or devices shown and described in FIGS. 4-11 to suit the particular application.

It is understood that additional steps, or different sequence of process steps described and illustrated may be used as known by those skilled in the art.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A high efficiency air filter for use in forced air circulation systems, the filter comprising:
An expandable media having a front side, a rear side, a top panel and a bottom panel, the media expandable along an axis;
a first elongate, rigid media support connected to the media top panel and extending transverse to the axis; and
a second elongate rigid media support connected to the media bottom panel and extending transverse to the axis, each first and second media support having a top, a bottom and side walls separating the top and the bottom walls defining a longitudinal cavity in each opposing end of the media support forming a modular filter core.

2. The filter of claim 1 wherein each media support further comprises a continuous piece of material having a first edge and an opposing second edge, the second edge oriented to overlap and connect to a portion of the material adjacent the first edge forming a rigid, closed section support.

3. The filter of claim 2 wherein the media top and media bottom panels are secured to the respective first media support and the second media support along substantially the entire length of the panel.

4. The filter of claim 1 further comprising an axial support for maintaining the filter modular core in an extended position along the axis for operable use, the vertical support engaging the first media support and the second media support.

5. The filter of claim 4 wherein the vertical support comprises:
a pair of end panels extending in a direction parallel to the media axis, each end panel having a top end, a bottom end and side panels forming an interior channel extending along the axis, the filter core media edges slidingly received in the channel.

6. The filter of claim 5 wherein the end panel top and bottom ends each further comprise a connector rigidly connected to the side panel, each connector having an insert portion slidingly engaged into the respective media support cavity thereby preventing the media from collapsing along the axis.

7. The filter of claim 6 wherein each end panel comprises a first portion and a second portion hingedly connected together at opposing ends, each connector is attached to one of the first and the second portions and further comprises a hinge allowing relative rotational movement between the respective first or second portion and connector insert.

8. The filter of claim 7 wherein the one of the first and second portions includes a locking bar and the other portion defines an opening for receipt of the bar to lock the first portion to the second portion in an extended position.

9. The filter of claim 4 further comprising a cabinet having a frame defining an interior cavity for receipt of the core filter in an extended position, the cabinet further comprising a first rail positioned vertically distant from a second rail, the first rail engageable with the first media support to prevent collapse of the media along the axis, the second rail engagable with the second media support.

10. The filter of claim 9 wherein the first media support includes an open section rail for operable engagement with a cabinet rail, the media support rail slidingly engaging the cabinet rail.

11. The filter of claim 1 wherein the media is pleated forming plurality of front edges and a plurality of rear edges, the filter further comprising a flexible separator connected to each of the edges on at least one of the front and rear edges positioned between the media supports, the separators maintaining substantially the same distance along the axis between when the front and rear edges when the media is in an extended position.

12. A high efficiency modular air filter for use in forced air circulation systems, the filter comprising:
An expandable pleated media having a width, opposing media edges, a front side, a rear side, a top panel and a bottom panel, the media expandable along a substantially vertical axis;
a flexible separator connected to each edge of at least one of the front or rear sides of the media between the media supports, the separators maintaining substantially the same distance between the edges along the axis when the media is in an extended position;
a first elongate, rigid, closed section media support connected to the media top panel and extending transverse to the axis, the media support having a length substantially the same length as the media width;
a second elongate, rigid, closed section media support connected to the media bottom panel and extending transverse to the axis, each first and second media support having a top, a bottom and side walls separating the top and the bottom walls defining a longitudinal through cavity extending the length of the media support forming the modular filter core; and
a vertical support engagable with the first and the second media supports to maintain the media in a vertically extended position on engagement of the support with the first and second media supports.

13. The filter of claim 12 wherein the vertical support comprises
A pair of end panels extending in a vertical direction parallel to the media axis, each end panel having a top end, a bottom end and side panels forming an interior channel extending along the axis, the media edges slidingly received in the channel; and
at least one connector rigidly connected to each side panel top and bottom end, each connector having an insert portion for sliding engagement into the respective media support cavity thereby preventing the media from collapsing along the axis.

14. The filter of claim 13 wherein the end panels include a first hinge, a second hinge and a third hinge allowing the end panels to rotate relative to the first and second media supports allowing the media to be collapsed to a first position and extended to the limits of the separators to a second position.

15. A method for assembling a modular filter for use in forced air circulation systems, the method comprising the steps of:
forming a pleated media having a top panel and a bottom panel which is expandable along an axis;
forming a first and a second rigid media support having a closed section along a length of the support defining a through cavity along the length;
securing the first media support to the media top panel and the second media support to the bottom media panel forming a media core; and
extending the media core along the axis; and
connecting the media core to an axial support to maintain the media core in an extended position along the axis.

16. The method of claim 15 wherein the step of connecting the media core to an axial support further comprises the steps of:
inserting the opposing media edges into channels defined by vertical end panels; and
connecting the vertical end panels at top and bottom ends to the respective first and second media support.

17. The method of claim 16 wherein the step of connecting the end panel top and the bottom ends further comprises the step of engaging inserts connected to the end panels transversely into the cavity of the first and the second media supports.

18. The method of claim 17 wherein the step of axially extending the media core further comprises the steps of:
rotating a first portion of the end panel relative to the second portion of the end panel; and
rotating the end panel first portion relative to the first media support and rotating the end panel second portion relative to the second media support.

19. The method of claim 15 wherein the step of connecting the core to the axial support further comprising the step of slidingly engaging the first and the second media supports into respective stationary rails.
